(19) United States
(12) Patent Application Publication
(10) Pub. No.: US 2019/0191660 A1
(43) Pub. Date: Jun. 27, 2019

(54) ANIMAL TOILET

(71) Applicant: SHARP KABUSHIKI KAISHA, Osaka (JP)

(72) Inventors: KAZUO TAKADA, Sakai City (JP); AYAKO SEKINE, Sakai City (JP)

(21) Appl. No.: 16/218,161

(22) Filed: Dec. 12, 2018

(30) Foreign Application Priority Data
Dec. 26, 2017 (JP) 2017-250222

(51) Int. Cl. A01K 1/01

(52) U.S. Cl. CPC A01K 1/011

(57) ABSTRACT

A pet toilet includes: a urine tray including (i) an excretion receiving container and (ii) a slidable frame on which the excretion receiving container is placed; a main container having a side-surface opening and an upper-surface opening and configured to support the urine tray in such a manner as to allow the urine tray to be slid into the main container through the side-surface opening; a support table placed on the main container, configured to support an animal while the animal is excreting, and having a bottom surface having slits that allow urine of the animal to (i) pass through the slits and (ii) drop into the excretion receiving container; and a load cell placed on an upper surface of the slidable frame and configured to support the excretion receiving container in such a manner as to be capable of measuring a weight.

This Nonprovisional application claims priority under 35 U.S.C. § 119 on Patent Application No. 2017-250222 filed in Japan on Dec. 26, 2017, the entire contents of which are hereby incorporated by reference.

### TECHNICAL FIELD

The present invention relates to an animal toilet capable of weighing an excretion of an animal.

### BACKGROUND ART

Patent Literature 1, for example, discloses and makes publicly known an animal toilet capable of weighing an excretion of an animal. The animal toilet disclosed in Patent Literature 1 includes (i) a support table that allows a pet aminal to stand thereon, (ii) an excretion tray configured to be slid in the main container to be positioned under the support table, and (iii) a weight scale provided under the excretion tray inside the main container. The weight scale supports the excretion tray inside the main container in such a manner as to lift the excretion tray from below.

The animal toilet is configured such that the excretion tray receives urine discharged by a pet on the support table and that the weight scale measures how much the excretion tray is heavier due to the received urine in order to weigh the urine discharged by the pet.

### CITATION LIST

### Patent Literature

[Patent Literature 1]

Japanese Patent Application Publication, Tokukai, No. 2017-153400 (Publication Date: Sep. 7, 2017)

### SUMMARY OF INVENTION

### Technical Problem

The above conventional animal toilet, which includes a weight scale positioned under an excretion tray, unfortunately has a large overall height.

An aspect of the present invention has been accomplished in view of the above issue involved with conventional animal toilets. It is an object of the present invention to provide an animal toilet that has a small overall height.

### Solution to Problem

In order to attain the above object, an animal toilet in accordance with an aspect of the present invention includes: an excretion tray including (i) an excretion container configured to receive an excretion of an animal and (ii) a placement member on which the excretion container is placed; a main container having a side-surface opening and an upper-surface opening and configured to support the excretion tray in such a manner as to allow the excretion tray to be slid into the main container through the side-surface opening; a support table placed on the main container, configured to support the animal while the animal is excreting, and having a bottom surface having a urine passage opening that allows urine of the animal to (i) pass through the urine passage opening and (ii) drop into the excretion container of the excretion tray under the urine passage opening; and at least one weight scale placed on an upper surface of the placement member of the excretion tray and configured to support the excretion container in such a manner as to be capable of measuring a weight.

### Advantageous Effects of Invention

An aspect of the present invention advantageously provides an animal toilet that has a small overall height.

### BRIEF DESCRIPTION OF DRAWINGS

FIG. 1 is an exploded perspective view of a pet toilet as an animal toilet in accordance with Embodiment 1 of the present invention, illustrating the configuration of the pet toilet.

(a) of FIG. 2 is a plan view of the pet toilet, illustrating the overall configuration of the pet toilet. (b) of FIG. 2 is a left side view of the pet toilet, illustrating the overall configuration of the pet toilet. (c) of FIG. 2 is a right side view of the pet toilet, illustrating the overall configuration of the pet toilet. (d) of FIG. 2 is a front side view of the pet toilet, illustrating the overall configuration of the pet toilet.

FIG. 3 is a cross-sectional view of the pet toilet, illustrating the overall configuration of the pet toilet.

FIG. 4 is a block diagram illustrating the configuration of a control device included in the pet toilet.

FIG. 5 is an exploded perspective view of an excretion tray, illustrating the configuration of a pet toilet in accordance with Embodiment 2 of the present invention.

FIG. 6 is a cross-sectional view of the pet toilet, illustrating the overall configuration of the pet toilet.

FIG. 7 is an exploded perspective view of an excretion tray, illustrating the configuration of a pet toilet in accordance with a variation of Embodiment 2 of the present invention.

FIG. 8 is a cross-sectional view of a variation of the pet toilet, illustrating the overall configuration of the variation of the pet toilet.

### DESCRIPTION OF EMBODIMENTS

### Embodiment 1

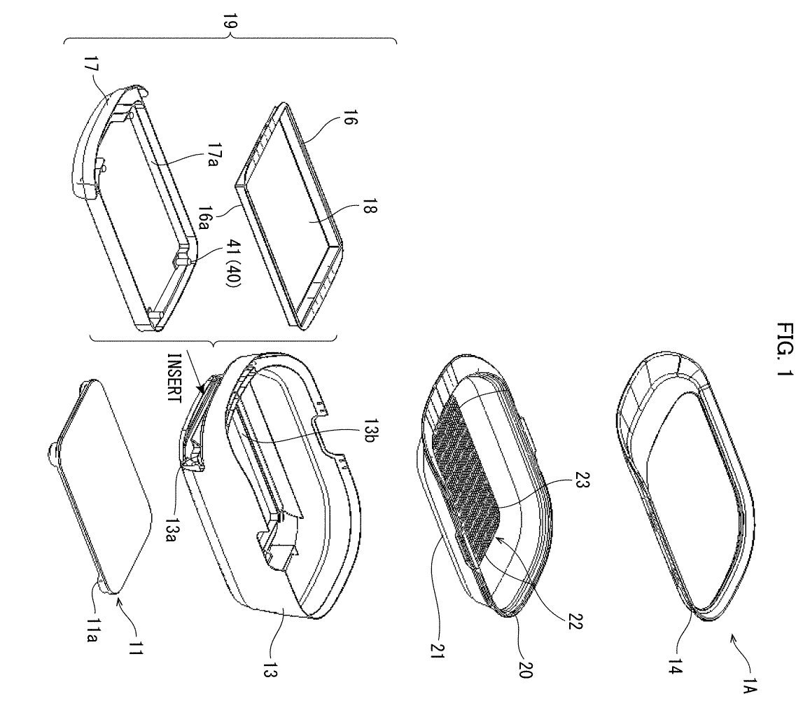

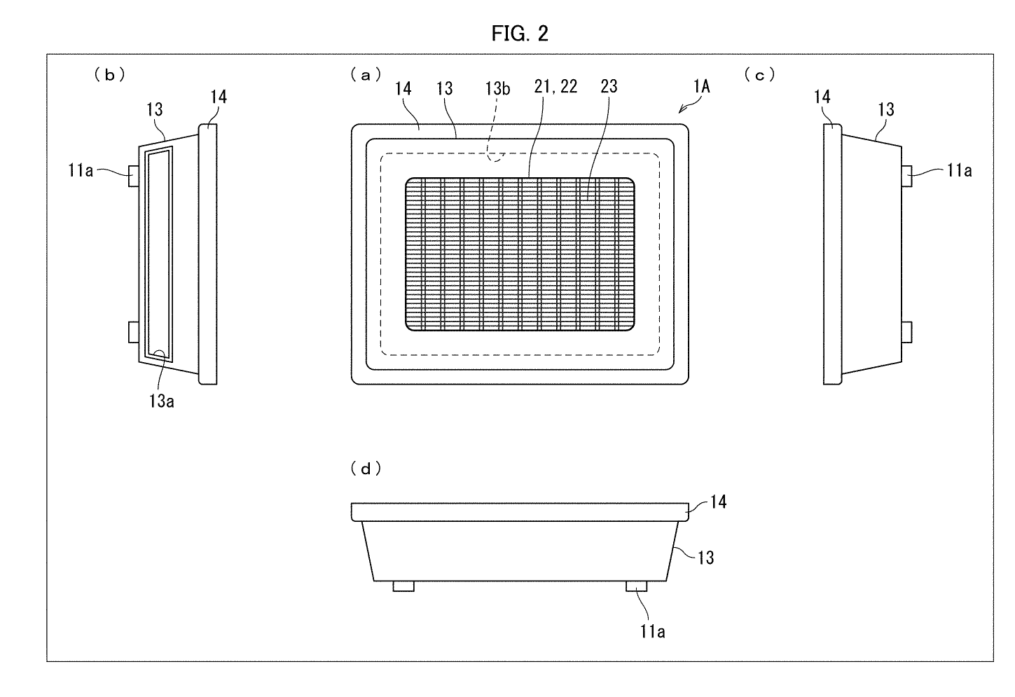

The following description will discuss an embodiment of the present invention with reference to FIGS. 1 to 4.

The present embodiment is a pet toilet as an example animal toilet. The pet toilet in accordance with the present embodiment is used by a pet such as a cat or a dog (that is, an animal kept domestically) when the pet urinates. The pet is not limited to a cat or a dog, and may be another animal. The present embodiment described here is a pet toilet having the function of measuring, for example, the amount of discharged urine and the number of times of urination for the pet's healthcare.

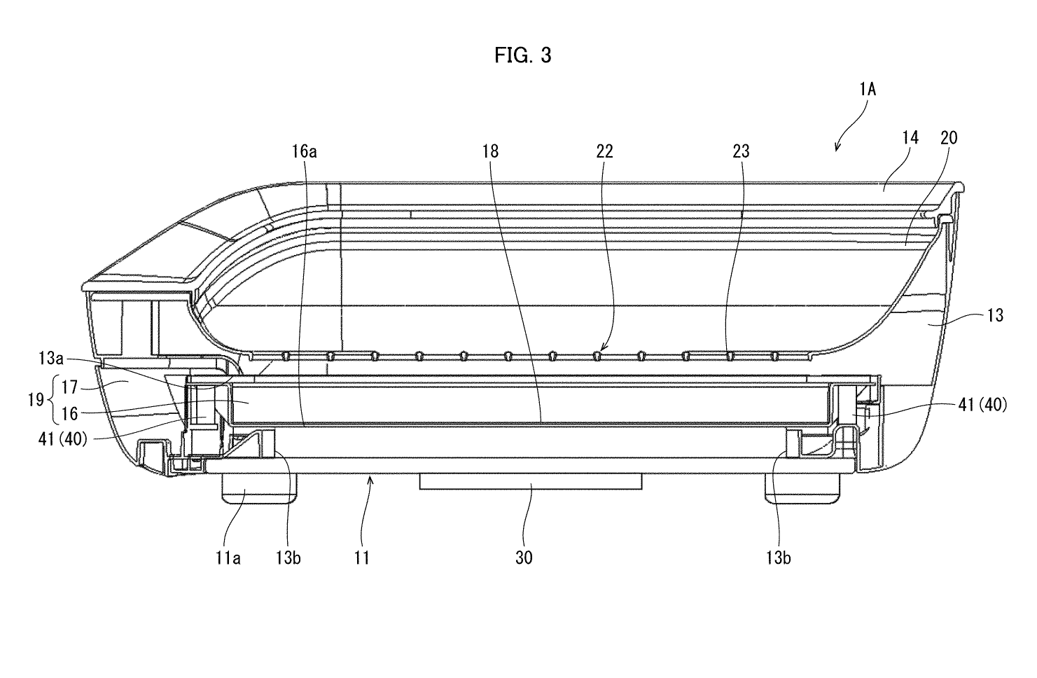

With reference to FIGS. 1 to 3, the description below deals with how a pet toilet 1A in accordance with the present embodiment is configured. FIG. 1 is an exploded perspective view of a pet toilet 1A in accordance with the present embodiment, illustrating the configuration of the pet toilet 1A. (a) of FIG. 2 is a plan view of the pet toilet 1A, illustrating the overall configuration of the pet toilet 1A. (b) of FIG. 2 is a left side view of the pet toilet 1A, illustrating the overall configuration of the pet toilet 1A. (c) of FIG. 2 is a right side view of the pet toilet 1A, illustrating the overall configuration of the pet toilet 1A. (d) of FIG. 2 is a front view of the pet toilet 1A, illustrating the overall configuration of the pet toilet 1A. FIG. 3 is a cross-sectional view of the pet toilet 1A, illustrating the configuration of the pet toilet 1A.

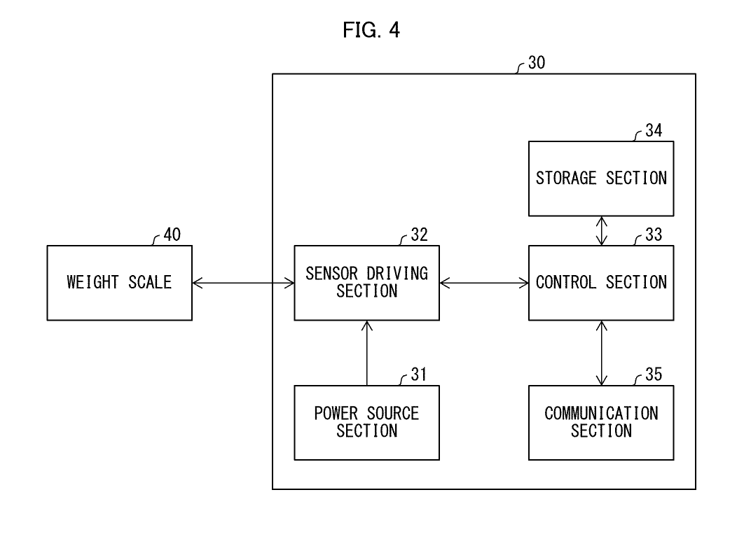

The pet toilet 1A in accordance with the present embodiment, as illustrated in FIGS. 1 and 2, includes a leg table 11, a main container 13, a support table 20, an upper-surface frame 14, a urine tray 19 as an excretion tray, and a weight scale 40. The pet toilet 1A further includes a control device 30 illustrated in FIG. 4 referred to later. The pet toilet 1A may further include a cover (not shown) that covers the support table 20 and the upper-surface frame 14.

The leg table 11 has a lower surface provided with four legs 11a each positioned at one of the four corners of the lower surface. The leg table 11 supports the main container 13 when the main container 13 is placed on the leg table 11.

The main container 13 is hollow, and has (i) an upper surface with an opening, (ii) a lower surface with an opening, and (iii) a side surface with an opening. As illustrated in FIGS. 1 and 3, the main container 13 has an upper-surface edge configured to receive the support table 20, on which an animal as a pet stands. The main container 13 is configured such that a urine tray 19 can be slid into a lower portion of the main container 13.

The support table 20 is a container-shaped table on which an animal stands for excretion. The support table 20 is inserted into the main container 13 through the upper-surface opening of the main container 13 to be (i) placed on the upper-surface edge of the main container 13 and (ii) supported by the main container 13. The upper-surface frame 14 is mounted on the upper-surface edge of the support table 20. The support table 20 has a bottom surface 21 having a mesh 22 including a plurality of slits 23 as urine passage openings. An excretion (in this example, urine) that an animal has discharged from above the mesh 22 passes through the slits 23 to fall onto the urine tray 19 so placed below as to face the bottom surface 21 of the support table 20.

The slits 23 allow a liquid to pass therethrough, but do not allow, for example, feces or an object (for example, a toy) that the animal has brought in its mouth. The bottom surface 21 of the support table 20 in accordance with the present embodiment is flat, and has a mesh 22 across the entire bottom surface 21. The mesh 22 may be provided in only a portion of the bottom surface 21.

The support table 20 may have, instead of the mesh 22, an opening with a different shape which opening allows an excretion to pass therethrough. As described above, the support table 20 in accordance with the present embodiment is shaped like a recessed container. The shape of the support table 20 is, however, not limited to such a shape. The pet toilet 1A may alternatively further include a member other than the support table 20 which member is supported by the support table 20 and be configured such that an animal stands on that member.

The support table 20 may be filled with a filler such as water-repellent gravel, sand, or glass beads. The support table 20 may itself be water-repellent to (i) prevent urine from remaining thereon and (ii) allow urine to easily run thereon.

The urine tray 19, as illustrated in FIG. 1, includes an excretion receiving container 16 as an excretion container and a slidable frame 17 as a placement member.

The excretion receiving container 16 is a vessel configured to receive urine of an animal. The excretion receiving container 16 is combined with an absorbing sheet 18 laid on a bottom 16a of the excretion receiving container 16. With this configuration, when an animal has discharged urine onto the absorbing sheet 18, the absorbing sheet 18 retains the urine. Further, after the urine is weighed, the absorbing sheet 18 is replaced with a new one. This allows the urine to be discarded easily. The absorbing sheet 18 is preferably, for example, a retainer containing a water absorbent resin and having high water absorbency. The retainer is, however, not limited to such a retainer, and may be any retainer capable of absorbing liquid such as sponge or paper.

The excretion receiving container 16 is detachable as described above, so the urine tray 19 can be detached from the main container 13 for removal of the absorbing sheet 18 and subsequent cleaning. The excretion receiving container 16 is thus easy to keep clean. This allows the pet toilet 1A to have high convenience.

The slidable frame 17 supports the dish-shaped excretion receiving container 16 placed thereon. The slidable frame 17 for the present embodiment is a rectangular frame having a central opening 17a. Fitting the excretion receiving container 16 into the central opening 17a of the slidable frame 17 from above allows the excretion receiving container 16 to be mounted on the slidable frame 17.

As illustrated in FIGS. 1 and 3, the urine tray 19 is detachable from the main container 13, and is slid into the main container 13 through a side-surface opening 13a at a side surface of the main container 13. This allows the urine tray 19 to be positioned under the bottom surface 21 of the support table 20 mounted on the main container 13, in other words, allows the urine tray 19 to face the bottom surface 21 of the support table 20 mounted on the main container 13. When the absorbing sheet 18 on the excretion receiving container 16 is to be replaced, the urine tray 19 is slid out of the main container 13 through the side-surface opening 13a. This configuration makes it possible to remove the urine tray 19 from the main container 13 and easily replace the absorbing sheet 18.

The weight scale 40 is configured to measure the amount of urine in the absorbing sheet 18 on the excretion receiving container 16. The weight scale 40 for the present embodiment includes load cells 41. A load cell is a device that converts a pressure from a load into an electric signal, and is capable of easily weighing urine of an animal.

The load cells 41 may each be, for example, a spring-type load cell, a piezoelectric load cell, a magnetostrictive load cell, a capacitive load cell, a gyroscopic load cell, or a strain gauge load cell. The weight scale 40 may alternatively include a member other than a load cell such as an electromagnetic equilibrium sensor or a tuning fork sensor.

The present embodiment is configured such that the weight scale 40 is placed on the upper surface of the slidable frame 17 of the urine tray 19. The excretion receiving container 16 is thus supported by the slidable frame 17 via the load cells 41. The load cells 41 support the excretion receiving container 16 in such a manner as to be capable of measuring a weight. The load cells 41 are thus contained between the slidable frame 17 and the excretion receiving container 16 of the urine tray 19. The slidable frame 17 and the excretion receiving container 16 of the urine tray 19 would, according to conventional art, be separated by a space for the excretion receiving container 16 to be lifted. The present embodiment includes load cells 41 in otherwise a sheer space. The pet toilet 1A in accordance with the present embodiment has a small overall height as compared to conventional counterparts.

The present embodiment includes a total of four load cells 41 each positioned on one of the four corners of the upper surface of the slidable frame 17, which is a rectangular frame.

The above configuration allows the four load cells 41 to support the excretion receiving container 16 in balance.

The present embodiment includes a control device 30 to control weight measurement involving the load cells 41. The control device 30 is, as illustrated in FIG. 3, in the form of a substrate on the lower surface of the leg table 11. The control device 30 may alternatively be in the form of a substrate on the upper surface of the leg table 11. The control device 30 is configured to be capable of supplying electric power to the load cells 41 and receiving electric signals from the load cells 41 when the urine tray 19 has been inserted into the main container 13 so that a terminal (not shown) of each load cell 41 becomes electrically connected to a terminal (not shown) extending from the control device 30.

With reference to FIG. 4, the description below deals with how the control device 30 is configured. FIG. 4 is a block diagram illustrating the configuration of the control device 30 included in the pet toilet 1A in accordance with the present embodiment.

The control device 30 for the present embodiment carries out operations such as controlling how the weight scale 40 is driven and receiving electric signals from the weight scale 40.

As illustrated in FIG. 4, the control device 30 includes a power source section 31, a sensor driving section 32, a control section 33, a storage section 34, and a communication section 35.

The power source section 31 supplies electric power to each section of the control device 30, namely, the sensor driving section 32, the control section 33, the storage section 34, and the communication section 35. The power source section 31 may be, for example, a battery.

The sensor driving section 32 is configured to receive electric signals each indicative of the value (measured value) of a weight that a weight scale 40 has measured. Specifically, the sensor driving section 32 supplies electric power to the weight scale 40 for operation of the weight scale 40. The sensor driving section 32 also receives data on measured values from the weight scale 40. More specifically, the sensor driving section 32, when having detected that a pet such as a dog or a cat has stepped onto the pet toilet 1A, causes the weight scale 40 to make a measurement. The sensor driving section 32 outputs, to the control section 33, information indicative of the measured values that the sensor driving section 32 has received.

The control section 33 calculates the weight of urine that a pet such as a dog or a cat has discharged. The present embodiment is configured as an example such that the measured values from the weight scale 40 indicate the combined weight of (i) the absorbing sheet 18 containing urine and (ii) the excretion receiving container 16. The control section 33 thus subtracts the value of the combined weight of the absorbing sheet 18 not containing urine and the excretion receiving container 16 from the value of the combined weight (indicated by the measured values received) of the absorbing sheet 18 containing urine and the excretion receiving container 16 to calculate the amount of urine that the absorbing sheet 18 has absorbed. The value of the combined weight of the absorbing sheet 18 not containing urine and the excretion receiving container 16 is stored in the storage section 34 in advance. This stored value of the combined weight may be the value of a weight that the weight scale 40 measured immediately after an old absorbing sheet 18 was replaced with a new one.

The control section 33 then stores, in the storage section 34, data on the measured time point of the urination and the measured weight of the urine. The control section 33 may transmit the data (stored in the storage section 34) from the communication section 35 to a terminal device of the owner of the pet. This configuration allows the owner of the pet to check the stored data on the time point (number) of the urination and the weight of the urine to learn the health condition of the pet.

The description below deals with how the pet toilet 1A configured as described above weighs urine.

As illustrated in FIG. 1, in a case where a pet (not shown) such as a dog or a cat has stood on the support table 20 and urinated, the urine runs through the slits 23 of the support table 20 to fall onto the excretion receiving container 16 of the urine tray 19 to be retained in the absorbing sheet 18.

The sensor driving section 32 of the control device 30 thus receives electric signals each indicative of the value (measured value) of a weight that a load cell 41 of the weight scale 40 has measured, and outputs, to the control section 33, information indicative of the measured values that the sensor driving section 32 has received.

The control section 33 calculates the weight of urine that a pet such as a dog or a cat has discharged. As the present embodiment includes four load cells 41 as the weight scale 40, the total weight value is approximately equal to the sum of the weight values that the four load cells 41 have outputted (the weight value is determined through an arithmetic operation of respective signals outputted from the four load cells 41, and is not simply the sum).

The measured values from the weight scale 40 indicate the combined weight of (i) the absorbing sheet 18 containing urine and (ii) the excretion receiving container 16. The control section 33 thus subtracts the value of the combined weight of the absorbing sheet 18 not containing urine and the excretion receiving container 16 from the value of the combined weight (indicated by the measured values received) of the absorbing sheet 18 containing urine and the excretion receiving container 16 to calculate the amount of urine that the absorbing sheet 18 has absorbed. The value of the combined weight of the absorbing sheet 18 not containing urine and the excretion receiving container 16 is stored in the storage section 34 in advance.

A cat as a pet, for example, discharges urine two to three times a day, in an amount of 20 g to 30 g a day per kilogram of the body weight. A mature cat, which typically has a body weight of 3 kg to 5 kg, discharges urine in an amount of normally 60 g to 150 g per day. When a mature cat is, for example, sick, it tends to discharge urine fewer times and/or in a smaller amount. In combination with this knowledge, the pet owner, for example, can learn the health condition of the pet such as a cat by using the pet toilet 1A of the present embodiment to measure how many times and/or how much (weight) the pet urinates. In a case where the storage section 34 is configured to store each measurement value, the present embodiment is capable of continuing to weigh urine even without replacement of the absorbing sheet 18 on the excretion receiving container 16.

As described above, the pet toilet 1A as an animal toilet in accordance with the present embodiment includes a urine tray 19 as an excretion tray including (i) an excretion receiving container 16 as an excretion container configured to receive an excretion of an animal and (ii) a slidable frame 17 as a placement member on which the excretion receiving container 16 is placed; a main container 13 having a side-surface opening 13a and an upper-surface opening and configured to support the urine tray 19 in such a manner as to allow the urine tray 19 to be slid into the main container 13 through the side-surface opening 13a; a support table 20 as a support table placed on the main container 13, configured to support the animal while the animal is excreting, and having a bottom surface 21 having slits 23 as a urine passage opening that allows urine of the animal to (i) pass through the slits 23 and (ii) drop into the excretion receiving container 16 of the urine tray 19 under the slits 23; and a weight scale 40 placed on an upper surface of the slidable frame 17 of the urine tray 19 and configured to support the excretion receiving container 16 in such a manner as to be capable of measuring a weight.

With the above configuration, the excretion receiving container 16 is supported by the slidable frame 17 via the weight scale 40, and the weight scale 40 supports the excretion receiving container 16 in such a manner as to be capable of measuring a weight. The weight scale 40 is thus contained between the slidable frame 17 and the excretion receiving container 16 of the urine tray 19. The slidable frame 17 and the excretion receiving container 16 of the urine tray 19 would, according to conventional art, be separated by a space for the excretion receiving container 16 to be lifted. The present embodiment includes a weight scale 40 in otherwise a sheer space. The pet toilet 1A as an animal toilet in accordance with the present embodiment has a small overall height as compared to conventional counterparts. This makes it possible to provide a pet toilet 1A that has a small overall height. The present embodiment has another advantage of eliminating the need for a complex structure in which an excretion receiving container is lifted as conventional.

The pet toilet 1A in accordance with the present embodiment includes a slidable frame 17 with an upper surface provided with a plurality of load cells 41 as weight scales 40. Specifically, the slidable frame 17 is in the shape of a rectangular frame having a central opening 17a, and the load cells 41 are provided on the four corners of the upper surface of the slidable frame 17. The above configuration allows the four load cells 41 to support the excretion receiving container 16 in balance.

The pet toilet 1A in accordance with the present embodiment is configured such that the weight scale 40 includes load cells 41. A load cell is a device that converts a pressure from a load into an electric signal. Using load cells 41 as the weight scale 40 makes it possible to easily weigh urine of an animal.

### Embodiment 2

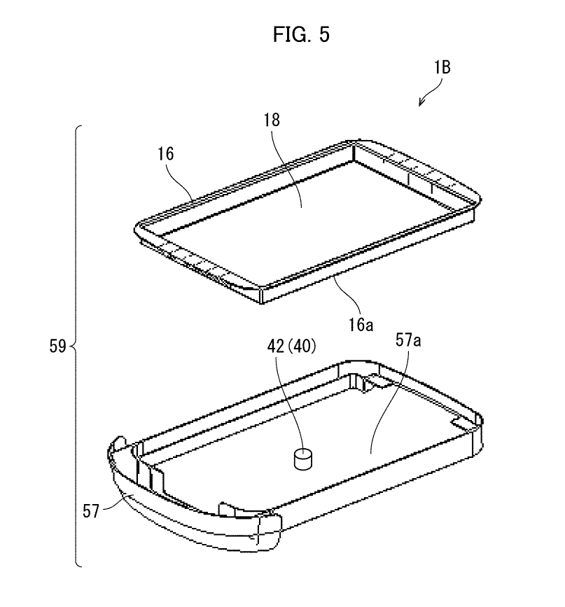

The following description will discuss another embodiment of the present invention with reference to FIGS. 5 to 8. The present embodiment is identical in configuration to Embodiment 1 except for the points described about the present embodiment. For convenience, any member of the present embodiment that is identical in function to a member illustrated in the drawings for Embodiment 1 is assigned the same reference sign, and is not described again here.

The present embodiment is a pet toilet 1B as an animal toilet which pet toilet 1B is identical to the pet toilet 1A of Embodiment 1 except that the slidable frame 17 is replaced with, as a placement member included in the excretion tray, a slidable member 57 having a bottom.

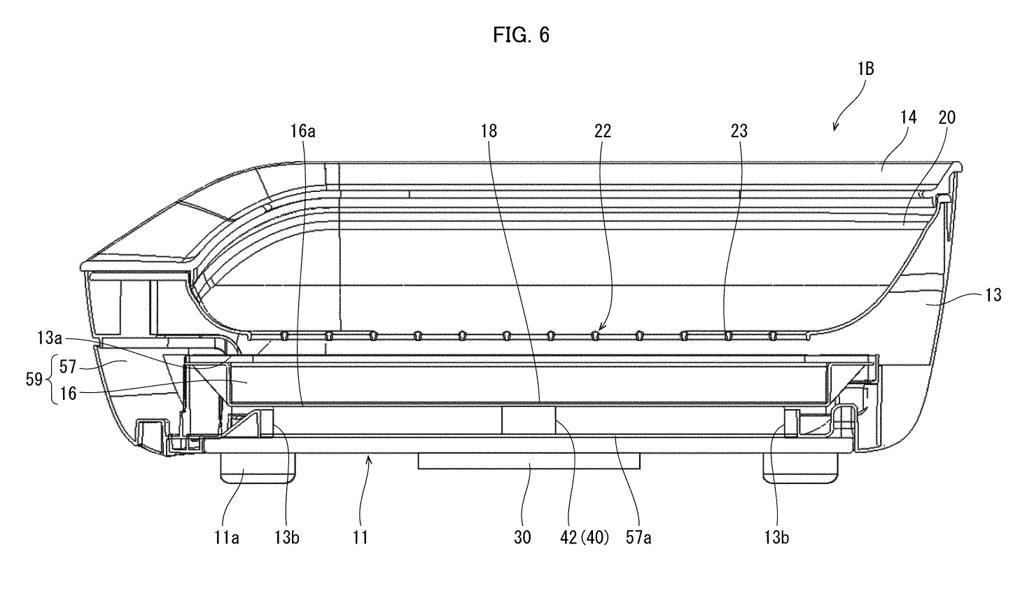

With reference to FIGS. 5 and 6, the description below deals with how the pet toilet 1B as an animal toilet in accordance with the present embodiment is configured. FIG. 5 is an exploded perspective view of a urine tray 59, illustrating the configuration of the pet toilet 1B in accordance with the present embodiment. FIG. 6 is a cross-sectional view of the pet toilet 1B, illustrating the overall configuration of the pet toilet 1B.

As illustrated in FIGS. 5 and 6, the pet toilet 1B in accordance with the present embodiment includes a slidable member 57 as a placement member which slidable member has a slidable member bottom 57a having an upper surface provided with a single load cell 42 as a weight scale 40.

As described above, in a case where the pet toilet 1B includes, as a placement member, a slidable member 57 having a bottom, the weight scale 40 can be provided on the upper surface of the slidable member bottom 57a. In this case, the weight scale 40 may include only one load cell 42.

The above configuration allows a single load cell 42 to support the excretion receiving container 16 in balance, making it possible to measure a weight.

The present invention is not limited to the above configurations, but may be altered variously within the scope of the claims of the present application. For instance, although the above description specifies the slidable member 57 as having a slidable member bottom 57a with an upper surface provided with a single load cell 42, the present invention is not limited to such a particular configuration.

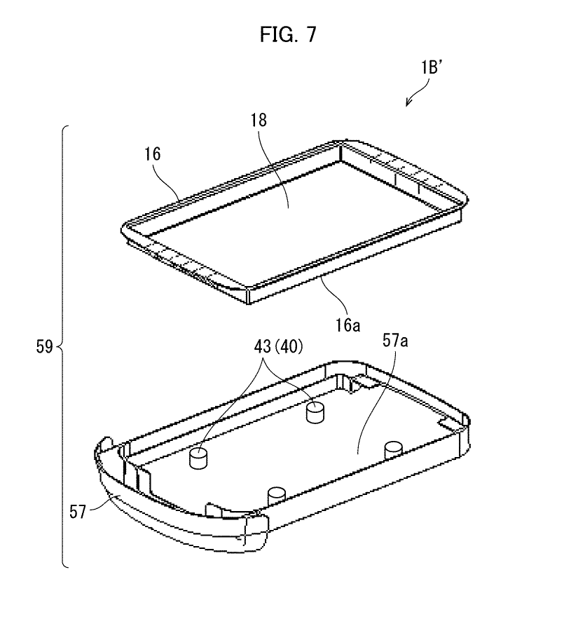

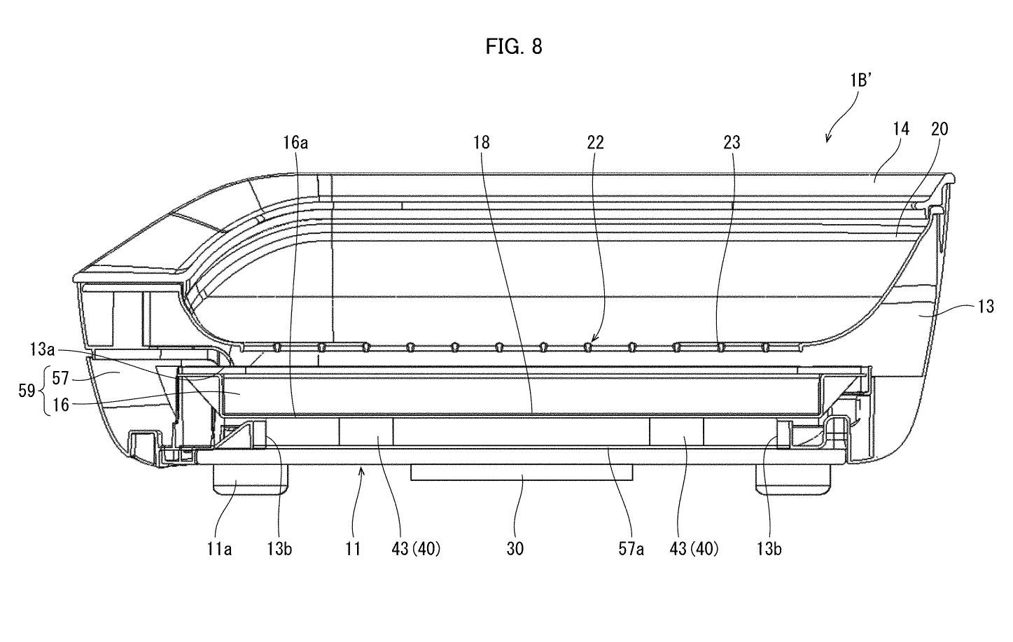

For instance, the present embodiment may be a pet toilet 1B′ including, as illustrated in FIGS. 7 and 8, a slidable member 57 having a slidable member bottom 57a with an upper surface provided with four load cells 44. Including a plurality (that is, two or more) of weight scales 40 as such makes it possible to easily support the excretion receiving container 16 in balance and measure a weight.

The embodiments described above are each configured to weigh only an excretion, but may each be configured to weigh the pet as well. In that case, the embodiments above are each configured such that the legs 11a supporting the main container 13 are replaced with weight sensors. This configuration allows the weight sensors to, when the pet has stepped onto the support table 20, measure a weight increase as the weight of the pet.

[Recap]

An animal toilet (pet toilet 1A, 1B, 1B′) in accordance with a first aspect of the present invention includes: an excretion tray (urine tray 19, 59) including (i) an excretion container (excretion receiving container 16) configured to receive an excretion of an animal and (ii) a placement member (slidable frame 17, slidable member 57) on which the excretion container (excretion receiving container 16) is placed; a main container 13 having a side-surface opening 13a and an upper-surface opening and configured to support the excretion tray (urine tray 19, 59) in such a manner as to allow the excretion tray to be slid into the main container 13 through the side-surface opening 13a; a support table 20 placed on the main container 13, configured to support the animal while the animal is excreting, and having a bottom surface 21 having a urine passage opening (slits 23) that allows urine of the animal to (i) pass through the urine passage opening and (ii) drop into the excretion container (excretion receiving container 16) of the excretion tray (urine tray 19, 59) under the urine passage opening; and at least one weight scale 40 (load cell 41 to 43) placed on an upper surface of the placement member (slidable frame 17, slidable member 57) of the excretion tray (urine tray 19, 59) and configured to support the excretion container (excretion receiving container 16) in such a manner as to be capable of measuring a weight.

With the above configuration, the animal toilet includes: an excretion tray including (i) an excretion container configured to receive an excretion of an animal and (ii) a placement member on which the excretion container is placed; a main container having a side-surface opening and an upper-surface opening and configured to support the excretion tray in such a manner as to allow the excretion tray to be slid into the main container through the side-surface opening; and a support table placed on the main container, configured to support the animal while the animal is excreting, and having a bottom surface having a urine passage opening that allows urine of the animal to (i) pass through the urine passage opening and (ii) drop into the excretion container of the excretion tray under the urine passage opening.

Conventional animal toilets of this type include a weight scale below an excretion tray and have a large overall height.

An animal toilet in accordance with an aspect of the present invention, in contrast, includes a weight scale on the upper surface of a placement member included in an excretion tray. With this configuration, the excretion container is supported by the placement member via the weight scale, and the weight scale supports the excretion container in such a manner as to be capable of measuring a weight.

The weight scale is thus contained between the placement member and the excretion container of the excretion tray. The placement member and the excretion container of the excretion tray would, according to conventional art, be separated by a space. An aspect of the present invention includes a weight scale in otherwise a sheer space. An animal toilet in accordance with an aspect of the present invention has a small overall height as compared to conventional counterparts.

This makes it possible to provide an animal toilet that has a small overall height.

An animal toilet (pet toilet 1A) in accordance with a second aspect of the present invention may be configured such that the at least one weight scale 40 includes a plurality of weight scales 40 (load cells 41).

With the above configuration, in a case where, for instance, the placement member is a rectangular frame having no bottom, a plurality of (for example, four) weight scales may be provided on the four corners of the upper surface of the placement member.

An animal toilet (pet toilet 1A) in accordance with a third aspect of the present invention may be configured such that the placement member (slidable frame 17) has a shape of a rectangular frame having a central opening 17a, and the plurality of weight scales 40 (load cells 41) are present on four corners of the upper surface of the placement member (slidable frame 17).

With the above configuration, in a case where the placement member is a rectangular frame having no bottom, four weight scales as a plurality of weight scales may be provided on the four corners of the upper surface of the placement member. Further, the above configuration allows the four weight scales to support the excretion container in balance.

An animal toilet (pet toilet 1B, 1B′) in accordance with a fourth aspect of the present invention may be configured such that the placement member (slidable member 57) has a bottom (slidable member bottom 57a) having an upper surface on which at least one of the at least one weight scale 40 (load cell 42, 43) is present.

With the above configuration, in a case where the placement member has a bottom, the weight scale can be provided on the upper surface of the bottom. In this case, there may be provided only one weight scale. The above configuration allows a single weight scale to support the excretion container in balance, making it possible to measure a weight. Further, including a plurality of weight scales makes it possible to easily support the excretion container in balance and measure a weight.

An animal toilet (pet toilet 1A, 1B, 1B′) in accordance with a fifth aspect of the present invention may be configured such that the at least one weight scale 40 includes a load cell 41, 42, 43.

A load cell is a device that converts a pressure from a load into an electric signal. Using a load cell as the weight scale makes it possible to easily weigh urine of an animal.

The present invention is not limited to the embodiments above, but can be altered variously by a skilled person in the art within the scope of the claims. The present invention also encompasses, in its technical scope, any embodiment derived by appropriately combining technical means disclosed in differing embodiments. Further, it is possible to form a new technical feature by combining the technical means disclosed in the respective embodiments.

### REFERENCE SIGNS LIST

1A Pet toilet (animal toilet)
1B, 1B′ Pet toilet (animal toilet)
11 Leg table
13 Main container
13a Side-surface opening
14 Upper-surface frame
16 Excretion receiving container (excretion container)
17 Slidable frame (placement member)
17a Central opening
18 Absorbing sheet
19 Urine tray (excretion tray)
20 Support table
21 Bottom surface
22 Mesh
23 Slit (urine passage opening)
30 Control device
31 Power source section
32 Sensor driving section
33 Control section
34 Storage section
35 Communication section
40 Weight scale
41 to 43 Load cell (weight scale)
57 Slidable member (placement member)
57a Slidable member bottom
59 Urine tray (excretion tray)

1. An animal toilet, comprising:
an excretion tray including (i) an excretion container configured to receive an excretion of an animal and (ii) a placement member on which the excretion container is placed;
a main container having a side-surface opening and an upper-surface opening and configured to support the excretion tray in such a manner as to allow the excretion tray to be slid into the main container through the side-surface opening;
a support table placed on the main container, configured to support the animal while the animal is excreting, and having a bottom surface having a urine passage opening that allows urine of the animal to (i) pass through the urine passage opening and (ii) drop into the excretion container of the excretion tray under the urine passage opening; and
at least one weight scale placed on an upper surface of the placement member of the excretion tray and configured to support the excretion container in such a manner as to be capable of measuring a weight.

2. The animal toilet according to claim 1, wherein
the at least one weight scale includes a plurality of weight scales.

3. The animal toilet according to claim 2, wherein
the placement member has a shape of a rectangular frame having a central opening, and
the plurality of weight scales are present on four corners of the upper surface of the placement member.

4. The animal toilet according to claim 1, wherein
the placement member has a bottom having an upper surface on which at least one of the at least one weight scale is present.

5. The animal toilet according to claim 1, wherein
the at least one weight scale includes a load cell.
